(19) United States
(12) Patent Application Publication
(10) Pub. No.: US 2004/0152388 A1
(43) Pub. Date: Aug. 5, 2004

(54) Energization processing apparatus and electron source manufacturing apparatus

(75) Inventors: Akihiro Kimura, Kanagawa (JP); Kazuhiro Oki, Chiba (JP); Shigeto Kamata, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/760,280

(22) Filed: Jan. 21, 2004

(30) Foreign Application Priority Data
Jan. 21, 2003 (JP) 2003-011734

(51) Int. Cl. H01J 9/00

(52) U.S. Cl. 445/24

(57) ABSTRACT

In an energization processing apparatus for performing, in a reduced-pressure atmosphere, an energization process on electric conductors which are placed on a substrate, separate temperature controlling mechanisms are provided for a vacuum region on the substrate where the electric conductors are placed and for the other region of the substrate, to thereby reduce a temperature difference on the substrate and avoid breakage of the substrate due to a difference in thermal expansion coefficient.

### BACKGROUND OF THE INVENTION

1. Field of the Invention

The present invention relates to an energization processing apparatus and an energization processing method. Further, the present invention relates to an electron source manufacturing apparatus and an electron source manufacturing method.

2. Related Background Art

Known electron-emitting devices are roughly divided into two: hot electron-emitting devices and cold cathode electron-emitting devices. Cold cathode electron-emitting devices are classified into field emission type electron-emitting devices, metal/insulating layer/metal type electron-emitting devices, surface conduction electron-emitting devices, etc.

The surface conduction electron-emitting devices utilize a phenomenon in which electrons are emitted from a thin, small-area film formed on a substrate by allowing a current to flow in the film in parallel to the film surface. The basic structure and manufacturing method of a surface conduction electron-emitting device are disclosed in Japanese Patent Application Laid-Open Nos. H7-235255 and H8-171849, for example.

The surface conduction electron-emitting devices are characterized by having on a substrate two device electrodes, which form a pair facing each other, and an electroconductive film, which is connected to the device electrodes and a part of which constitutes an electron-emitting region. Also, there is a fissure in a part of the electroconductive film.

A deposit film mainly containing carbon or a carbon compound, or both, is formed at an end of the fissure.

If such electron-emitting devices are arranged on a substrate and connected to one another through wires, an electron source having the plural surface conduction electron-emitting devices is obtained.

If the electron source is combined with a phosphor, a display panel for an image forming apparatus is obtained.

Up to now, electron sources like this have been manufactured by the following method as disclosed in Japanese Patent Application Laid-Open No. 2000-311594:

First, an electron source substrate is prepared by forming on a substrate plural devices and wires that connect the devices to one another. The devices are each composed of an electroconductive film and a pair of device electrodes connected to the electroconductive film. Next, a region of the obtained electron source substrate is covered with a vessel. The air in the vessel is exhausted and then a voltage is applied through an external terminal to the exposed wires that are not covered with the vessel, thereby forming a fissure in the electroconductive film of each device. Gases containing an organic substance are led into the vessel and a voltage is again applied through the external terminal to each of the devices in the presence of the organic substance to deposit carbon or a carbon compound in the vicinity of the fissure. As a result, the devices are turned into electron-emitting devices and an electron source composed of the plural electron-emitting devices is obtained.

In this electron source manufacturing method employed heretofore, a current flowing in the wires and the devices during the energization process generates heat on the surface of the substrate and raises the temperature of the substrate surface. The heat generated by the energization is transmitted to the atmosphere at varying speed since the one region of the substrate surface is under a reduced-pressure atmosphere, whereas the other region is under the atmospheric air, causing the heat to dissipate faster from the other region. As a result, a temperature difference is created on the substrate surface. If the temperature difference is extremely large, the risk of cracking the substrate could be increased and it is not desirable for the yield.

### SUMMARY OF THE INVENTION

The present invention has been made in view of the above, and an object of the present invention is therefore to provide an energization processing apparatus and an energization processing method, and an electron source manufacturing apparatus and an electron source manufacturing method that have a reduced risk of cracking a substrate.

The present invention provides an energization processing apparatus for performing, in a reduced-pressure atmosphere, an energization process on electric conductors which are placed on a substrate, including:

a vessel which has an exhaust hole and which covers the electric conductors and one region on a surface of the substrate where the electric conductors are placed, to thereby create an airtight atmosphere between the substrate and the vessel;

a first temperature adjusting mechanism for adjusting a temperature of the one region of the substrate; and

a second temperature adjusting mechanism for adjusting a temperature of the other region of the substrate.

Further, the present invention provides an electron source manufacturing apparatus for energizing, in a reduced-pressure atmosphere, electric conductors which are placed on a substrate to form electron-emitting regions in the electric conductors, including:

a vessel which has an exhaust hole and which covers the electric conductors and one region on a surface of the substrate where the electric conductors are placed, to thereby create an airtight atmosphere between the substrate and the vessel;

a first temperature adjusting mechanism for adjusting a temperature of the one region of the substrate; and

a second temperature adjusting mechanism for adjusting a temperature of the other region of the substrate.

Further, the present invention provides an energization processing method for performing, in a reduced-pressure atmosphere, an energization process on electric conductors which are placed on a substrate, including the steps of:

covering the electric conductors and one region on a surface of the substrate where the electric conductors are placed with a vessel which has an exhaust hole, to thereby create an airtight atmosphere between the substrate and the vessel;

reducing a pressure of the airtight atmosphere; and

heating the other region of the substrate at a temperature higher than the temperature of the one region and energizing the electric conductors.

Further, the present invention provides electron source manufacturing method for energizing, in a reduced-pressure atmosphere, electric conductors which are placed on a substrate to form electron-emitting regions in the electric conductors, including the steps of:

covering the electric conductors and one region on a surface of the substrate where the electric conductors are placed with a vessel which has an exhaust hole, to thereby create an airtight atmosphere between the substrate and the vessel;

reducing a pressure of the airtight atmosphere; and

heating the other region of the substrate at a temperature higher than the temperature of the one region and energizing the electric conductors.

### BRIEF DESCRIPTION OF THE DRAWINGS

FIG. 1 is a sectional view showing a structure of an electron source manufacturing apparatus according to the present invention;

FIG. 2 is a perspective view of an electron source substrate and its peripheral portion in the apparatus of FIG. 1 with the peripheral portion partially cut off;

FIG. 3 is a schematic sectional view of an embodiment according to the present invention;

FIG. 4 is a schematic sectional view of an embodiment according to the present invention; and

FIG. 5 is a schematic sectional view of an embodiment according to the present invention.

### DESCRIPTION OF THE PREFERRED EMBODIMENTS

An energization processing apparatus according to the present invention for performing, in a reduced-pressure atmosphere, an energization process on electric conductors which are placed on a substrate, includes:

a vessel which has an exhaust hole and which covers the electric conductors and one region on a surface of the substrate where the electric conductors are placed, to thereby create an airtight atmosphere between the substrate and the vessel;

a first temperature adjusting mechanism for adjusting a temperature of the one region of the substrate; and

a second temperature adjusting mechanism for adjusting a temperature of the other region of the substrate.

An electron source manufacturing apparatus according to the present invention for energizing, in a reduced-pressure atmosphere, electric conductors which are placed on a substrate to form electron-emitting regions in the electric conductors, includes:

a vessel which has an exhaust hole and which covers the electric conductors and one region on a surface of the substrate where the electric conductors are placed, to thereby create an airtight atmosphere between the substrate and the vessel;

a first temperature adjusting mechanism for adjusting a temperature of the one region of the substrate; and

a second temperature adjusting mechanism for adjusting a temperature of the other region of the substrate.

An energization processing method according to the present invention for performing, in a reduced-pressure atmosphere, an energization process on electric conductors which are placed on a substrate, includes the steps of:

covering the electric conductors and one region on a surface of the substrate where the electric conductors are placed with a vessel which has an exhaust hole, to thereby create an airtight atmosphere between the substrate and the vessel;

reducing a pressure of the airtight atmosphere; and

heating the other region of the substrate at a temperature higher than the temperature of the one region and energizing the electric conductors.

An electron source manufacturing method according to the present invention for energizing, in a reduced-pressure atmosphere, electric conductors which are placed on a substrate to form electron-emitting regions in the electric conductors, includes the steps of:

covering the electric conductors and one region on a surface of the substrate where the electric conductors are placed with a vessel which has an exhaust hole, to thereby create an airtight atmosphere between the substrate and the vessel;

reducing a pressure of the airtight atmosphere; and

heating the other region of the substrate at a temperature higher than the temperature of the one region and energizing the electric conductors.

A more detailed description of the present invention is given below.

An electron source manufacturing apparatus of the present invention is equipped with a supporter for supporting a substrate on which electric conductors are formed in advance and a vessel for covering the substrate supported by the supporter. The vessel covers a region of a surface of the substrate to create an airtight space on the substrate while leaving some of wires, which are formed on the substrate and connected to the electric conductors, exposed outside of the vessel. The vessel has a gas inlet and a gas outlet to which a measure for introducing gas to the vessel and a measure for discharging gas from the vessel are connected, respectively. In this way, the atmosphere in the vessel can be set as desired. The substrate on which the electric conductors are formed in advance receives electrical treatment to form electron-emitting regions in the electric conductors and turn the electric conductors into an electron source. Also provided in the apparatus is a measure for energizing the exposed wires that are not covered with the vessel. The apparatus is further equipped with a first temperature adjusting mechanism for adjusting the temperature of one region of the substrate and a second temperature adjusting mechanism for adjusting the temperature of the other region of the substrate. This electron source manufacturing apparatus can reduce a temperature difference caused by a difference in speed of transmitting heat, which is generated by energization, to the atmosphere and thus can prevent the substrate from cracking.

A first step in an electron source manufacturing method of the present invention is to place on a supporter a substrate on which electric conductors and wires connected to the electric conductors are formed in advance. The electric conductors on the substrate are covered with a vessel while leaving some of the wires exposed outside of the vessel. In this way, the electric conductors are put in an airtight space created on the substrate. The supporter has a first temperature adjusting mechanism for adjusting the temperature of one region of the substrate and a second temperature adjusting mechanism for adjusting the temperature of the other region of the substrate. Next, the atmosphere in the vessel is set as desired by, for example, reducing the pressure in the vessel or by introducing a specific gas into the vessel. Then an energization process, e.g., application of voltage, is performed on the electric conductors through the exposed wires that are outside of the vessel. The energization process is an operation for forming electron-emitting regions in the electric conductors in order to turn the electric conductors into an electron source. The energization process may be performed more than once under various atmosphere. For instance, after the electric conductors on the substrate are covered with the vessel leaving some of the wire exposed, the atmosphere in the vessel is set to a first atmosphere to carry out the above energization process and then the atmosphere in the vessel is set to a second atmosphere to carry out the above energization process for the second time, while heating the other region at a temperature higher than the temperature of the one region in each of those energization steps. Through the above procedure, excellent electron-emitting regions are formed in the electric conductors and an electron source is thus obtained. As will be described later, the first atmosphere is preferably a reduced-pressure atmosphere and the second atmosphere preferably contains a specific gas such as a carbon compound. This electron source manufacturing method can reduce a temperature difference caused by a difference in speed of transmitting heat, which is generated by an energization process, to the atmosphere and thus can prevent the substrate from cracking.

Shown below is a preferred embodiment mode of the present invention.

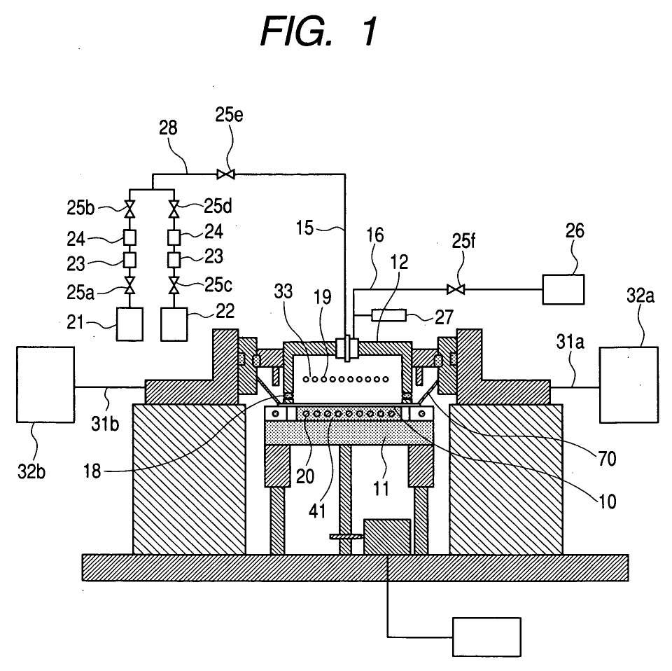

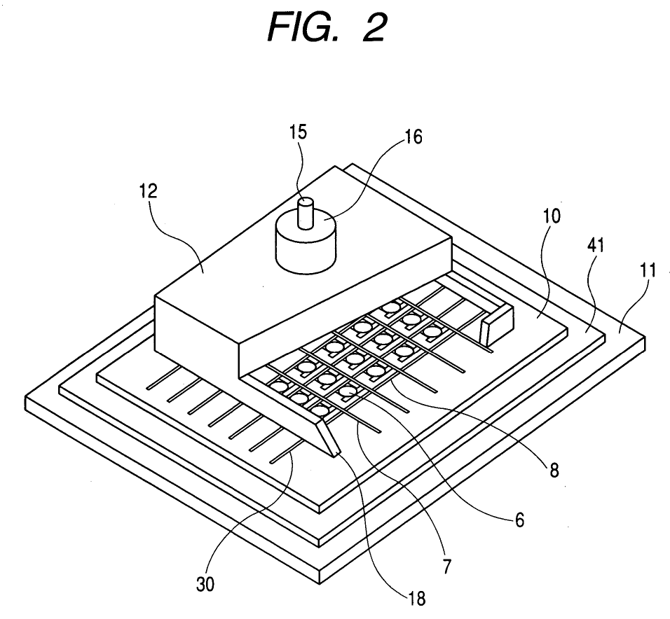

FIGS. 1 and 2 illustrate an electron source manufacturing apparatus according to this embodiment mode. FIG. 1 is a sectional view of the apparatus and FIG. 2 is a perspective view showing an electron source substrate and its peripheral portion in FIG. 1. As shown in FIGS. 1 and 2, the electron source manufacturing apparatus includes electric conductors 6 for forming electron-emitting devices, X-direction wires 7, Y-direction wires 8, an electron source substrate 10, a supporter 11, a vacuum vessel 12, a gas inlet 15, a gas outlet 16, a seal member 18, a diffusion plate 19, water pipes 20, hydrogen or organic substance gas 21, carrier gas 22, a moisture removing filter 23, a gas flow rate controller 24, valves 25a to 25f, a vacuum pump 26, a vacuum gauge 27, a pipe 28, lead-out wires 30, drivers 32a and 32b each composed of a power supply and a current controlling system, wires 31a and 31b for connecting the drivers to the lead-out wires 30 of the electron source substrate, openings 33 in the diffusion plate 19, a heat conductive member 41, and a probe unit 70.

The supporter 11 is provided to hold and fix the electron source substrate 10, and has a mechanism for mechanically fixing the electron source substrate, such as a vacuum chucking mechanism, an electrostatic chucking mechanism, or a fixing jig.

Placed on the supporter 11 is the heat conductive member 41. The heat conductive member 41 is sandwiched between the supporter 11 and the electron source substrate 10, or buried in the supporter 11, in a manner that prevents the heat conductive member from interfering with the working of the supporter's mechanism that holds and fixes the electron source substrate 10. A heater (not shown) and the water pipes 20 are provided in the heat conductive member 41, enabling heating and cooling of the electron source substrate 10 through the heat conductive member 41 as the need arises. The heat conductive member is divided into two regions as will be described later, and the temperature can be controlled separately for the two regions.

The concentration distribution of introduced gas due to the temperature distribution and device non-uniformity due to the heat distribution on the substrate can be reduced if the heat generated in an energization process step is dissipated quickly and successfully. Then, an electron source having excellent uniformity can be obtained.

The vacuum vessel 12 is a container made of glass, stainless steel, or like other material that allows the vessel to release little gas. The vacuum vessel 12 is structured to cover a region of the electron source substrate 10 where the electric conductors 6 are formed while leaving the lead-out wire portion exposed. The vacuum vessel 12 is also structured to withstand at least a pressure ranging from 1×10⁻⁴ Pa to atmospheric pressure.

The seal member 18 is for maintaining the airtightness of the space created between the electron source substrate 10 and the vacuum vessel 12. An O-ring or a rubber sheet is employed as the seal member 18.

The organic substance gas 21 is a organic substance used in activation of electron-emitting devices which will be described later, or a gas mixture obtained by diluting a gaseous organic substance with nitrogen, helium, argon, or the like. Also, gas for accelerating formation of a fissure in an electroconductive film, e.g., reducing hydrogen gas, may be introduced in the vacuum vessel 12 during an energization forming operation, which will be described later. To introduce gas in other steps as this, the vacuum vessel 12 is connected to the pipe 28 using an inlet pipe and the valve member 25e.

Examples of organic substances used in the activation of electron-emitting devices include aliphatic hydrocarbons such as alkane, alkene, and alkyn; aromatic hydrocarbons; alcohols; aldehydes; ketones; amines; nitrites; and organic acids such as phenol, carvone, and sulfonic acid. More specific examples include saturated hydrocarbons expressed as CₙH₂ₙ₊₂ such as methane, ethane, and propane; unsaturated hydrocarbons expressed as CₙH₂, such as ethylene and propylene; benzene; toluene; methanol; ethanol; acetaldehyde; methyl ethyl ketone; methyl amine; ethyl amine; phenol; benzonitrile; and acetonitrile.

If an organic substance chosen is gaseous at normal temperature, the substance can serve as it is as the organic substance gas 21. On the other hand, if an organic substance chosen is liquid or solid at normal temperature, the organic substance is vaporized or sublimed within the vessel, or the vaporized or sublimed substance is further mixed with diluent gas, to make the organic substance usable as the organic substance gas 21. Employed as the carrier gas 22 are inert gases such as nitrogen, argon, and helium.

The organic substance gas 21 and the carrier gas 22 are mixed at a certain ratio and the mixture is led into the vacuum vessel 12. The flow rate and the mixture ratio of the two gases are controlled by the gas flow rate controller 24. The gas flow rate controller 24 is composed of a mass flow controller, a solenoid valve, and others. The gas mixture is heated as the need arises to an appropriate temperature by a heater (not shown) that is provided in the periphery of the pipe 28, and then led into the vacuum vessel 12 through the inlet 15. Preferably, the gas mixture is heated to a temperature equal to that of the electron source substrate 10.

The moisture removing filter 23 is preferably placed at some point in the pipe 28 to remove moisture from the introduced gas. The moisture removing filter 23 is formed from a hygroscopic material such as silica gel, a molecular sieve, or magnesium hydrate.

The gas mixture introduced in the vacuum vessel 12 is discharged at a certain exhaust rate by the vacuum pump 26 through the gas outlet 16, thereby keeping the gas mixture pressure in the vacuum vessel 12 constant. The vacuum pump 26 used in the present invention is a pump that is low vacuum and preferably oil-free, such as a dry pump, a diaphragm pump, or a scroll pump.

The gas mixture pressure in this embodiment is preferably equal to or higher than a level that makes a mean free path λ of gas molecules that constitute the gas mixture sufficiently smaller than the size of the vacuum vessel 12 on the inside in terms of shortening the activation time and improving the uniformity, although depending on the type of organic substance used in the activation. This is a so-called viscous flow region, and the pressure in the region is from several hundreds Pa (a few Torr) to atmospheric pressure.

The diffusion plate 19 is placed between the gas inlet 15 of the vacuum vessel 12 and the electron source substrate 10 to control the flow of the gas mixture and uniformly supply the organic substance throughout the substrate surface. As a result, the electron-emitting devices can have an improved uniformity.

The lead-out electrodes 30 of the electron source substrate are outside of the vacuum vessel 12, and are connected to the wires 31 through the probe unit 70 to be connected to the drivers 32.

In this embodiment mode and in embodiments that follow, the vacuum vessel only has to cover the electric conductors 6 on the electron source substrate and nothing else, thus allowing size reduction of the apparatus. Leaving the wiring portion of the electron source substrate exposed outside of the vacuum vessel also facilitates the electrical connection of the electron source substrate electrically to a power supply apparatus (driver), which performs electrical treatment.

As a flow of the gas mixture containing an organic substance is started in the vacuum vessel 12 in the manner described above, the drivers 32 are put into operation to apply a pulse voltage to each of the electron-emitting devices on the substrate 10 through the wires 31. The electron-emitting devices are thus activated.

For specific examples of how an electron source is manufactured using the above manufacturing apparatus, detailed descriptions will be given in the following embodiments.

The present invention particularly relates to the heat conductive member which is placed on the supporter and which has a temperature adjusting mechanism in the embodiment mode described above.

What the embodiment mode particularly aims to achieve is reduction of a temperature difference created on the electron source substrate 10 during activation between the region inside the vacuum vessel and the region outside the vacuum vessel, and resultantly prevention of breakage of the electron source substrate 10.

For that reason, this embodiment mode is characterized by having a first temperature adjusting mechanism for adjusting the temperature of one region of the electron source substrate 10 and a second temperature adjusting mechanism for adjusting the temperature of the other region. A detailed description will be given in the following embodiments on how the temperature of the substrate is adjusted by the first temperature adjusting mechanism and the second temperature adjusting mechanism.

Embodiments

The present invention is described in detail below through specific embodiments. However, the embodiments are not to limit the present invention, and the present invention includes substitution of components and modifications in design that help to achieve an object of the present invention.

Embodiment 1

In this embodiment, an electron source having plural surface conduction electron-emitting devices is manufactured using an apparatus according to the present invention shown in FIG. 1.

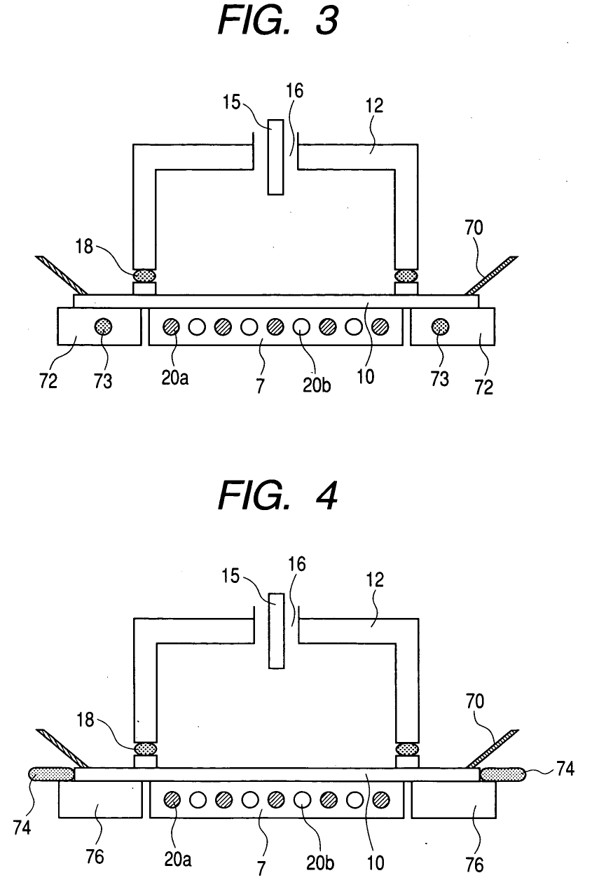

FIG. 3 is a sectional view illustrating a first temperature adjusting mechanism and a second temperature adjusting mechanism in an apparatus of this embodiment. Schematically shown in FIG. 3 are an electron source substrate 10, which is being activated, a heat conductive member 71, which has the first temperature adjusting mechanism, a heat conductive member 72, which has the second temperature adjusting mechanism, a vacuum vessel 12, and a probe unit 70.

Although not shown in the drawing, devices, device electrodes, and wires are formed on the electron source substrate 10, which is a 900 mm×580 mm glass substrate having a thickness of 2.8 mm. This embodiment has a heat conductive member divided into two: the heat conductive member 71 which has the first temperature adjusting mechanism to control the temperature of the region inside the vacuum vessel 12 and the heat conductive member 72 which has the second temperature adjusting mechanism to control the temperature of the region outside of the vacuum vessel 12. In this way, the temperature inside the vessel and the temperature outside the vessel can be adjusted separately. The heat conductive member 71 having the first temperature adjusting mechanism is a 856 mm×534 mm plate formed from an aluminum alloy, which is high in heat conductivity, to a thickness of 30 mm and has a heater 20a and water pipes 20b inside. The heat conductive member 72 having the second temperature adjusting mechanism is formed from an aluminum alloy, has a rectangular, frame-like shape whose outer measurement is 1000 mm×680 mm and inner measurement is 867 mm×545 mm, and is 30 mm in thickness. A heater 73 is provided inside the heat conductive member 72. The heat conductive member 72 may have water pipes in addition to the heater similar to the heat conductive member 71.

The temperature of the electron source substrate 10 is adjusted in advance by the heater 20a and a heater 73 of the thus structured apparatus to reach 80° C. Next, the vacuum vessel 12 is vacuum-exhausted through a gas outlet 16 to set the pressure in the vacuum vessel 12 to 1×10⁻⁴ Pa or lower. Then, tolunitrile is introduced into the vacuum vessel 12 through a gas inlet to set the pressure in the vacuum vessel 12 to 2×10⁻⁴ Pa. Thereafter, the probe unit 70 is connected to the wires on the electron source substrate 10 to carry out an energization process while water at a temperature of 70° C. is let flow in the water pipes 20b of the heat conductive member 71 having the first temperature adjusting mechanism and the temperature of the heat conductive member 72 having the second temperature adjusting mechanism is adjusted by the heater 73 to thereby set the temperature of the substrate to 85° C. During the energization process, heat is generated from the wires and devices formed on the surface of the electron source substrate 10. A region of the substrate surface that is exposed to the atmospheric air dissipates this heat, thus lowering the temperature of the exposed region, unlike a region on the substrate surface that is covered with the vacuum vessel 12 and is under the reduced-pressure atmosphere. However, the temperature difference between the two regions of the substrate is reduced to almost zero by raising the temperature of the heat conductive member 72 higher than that of the heat conductive member 71. The energization process can therefore be carried out without suffering from the temperature difference problem.

This embodiment has been successful in manufacturing electron-emitting devices of excellent electron emission characteristics using the above electron source manufacturing apparatus of the present invention through an energization process performed on the devices, which is capable of preventing the substrate from cracking by reducing the temperature difference in the substrate. The heat conductive member 71 and the heat conductive member 72 may be set to temperatures different from those shown in this embodiment to suit the amount of heat generated by the wires and the devices.

Embodiment 2

Similar to Embodiment 1, in this embodiment, an electron source having plural surface conduction electron-emitting devices is manufactured using an apparatus according to the present invention shown in FIG. 1.

FIG. 4 is a sectional view illustrating a first temperature adjusting mechanism and a second temperature adjusting mechanism in an apparatus of this embodiment. Schematically shown in FIG. 4 are an electron source substrate 10, which is being activated, a heat conductive member 71, which has the first temperature adjusting mechanism, a heat insulating member 76, a vacuum vessel 12, and a probe unit 70. The heat insulating member 76 is formed from ceramic which is low in heat conductivity. A rubber heater 74 is placed on each end face of the electron source substrate 10. For the rest, the apparatus of this embodiment is structured in a manner identical to the apparatus of Embodiment 1.

The temperature of the electron source substrate 10 is adjusted in advance by a heater 20a and a rubber heater 74 of the thus structured apparatus to reach 80° C. Next, the vacuum vessel 12 is vacuum-exhausted through a gas outlet 16 to set the pressure in the vacuum vessel 12 to 1×10⁻⁴ Pa or lower. Then, tolunitrile is introduced into the vacuum vessel 12 through a gas inlet to set the pressure in the vacuum vessel 12 to 2×10⁻⁴ Pa. Thereafter, the probe unit 70 is connected to wires on the electron source substrate 10 to carry out an energization process while water at a temperature of 70° C. is let flow in water pipes 20b of the heat conductive member 71 having the first temperature adjusting mechanism and the substrate is heated by the rubber heater 74 from each substrate end face to thereby set the temperature of the substrate to 85° C. This embodiment employs the heat insulating member 76 formed from ceramic which has poor heat conductivity, instead of the heat conductive member 72 which has the second temperature adjusting mechanism and is used in Embodiment 1. The heat insulating member 76 prevents the substrate from losing the heat given by the rubber heater 74. It can therefore be said that an apparatus structured as the apparatus of this embodiment hardly suffers from the problem of temperature difference in a substrate and is capable of providing effects similar to those obtained in Embodiment 1.

This embodiment has been successful in manufacturing electron-emitting devices of excellent electron emission characteristics using the above electron source manufacturing apparatus of the present invention through an energization process performed on the devices which is capable of preventing the substrate from cracking by reducing the temperature difference in the substrate.

Embodiment 3

Similar to Embodiment 1, in this embodiment, an electron source having plural surface conduction electron-emitting devices is manufactured using an apparatus according to the present invention shown in FIG. 1.

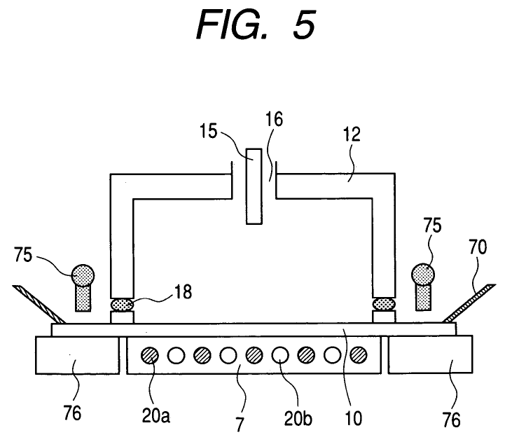

FIG. 5 is a sectional view illustrating a first temperature adjusting mechanism and a second temperature adjusting mechanism in an apparatus of this embodiment. Schematically shown in FIG. 5 are an electron source substrate 10, which is being activated, a heat conductive member 71, which has the first temperature adjusting mechanism, a heat insulating member 76, a vacuum vessel 12, and a probe unit 70. The heat insulating member 76 is formed from ceramic which is low in heat conductivity. A hot air blower 75 is provided to heat the electron source substrate 10 from above. For the rest, the apparatus of this embodiment is structured in a manner identical to the apparatus of Embodiment 1.

The temperature of the electron source substrate 10 is adjusted in advance by a heater 20a and a heater blower 75 of the thus structured apparatus to reach 80° C. Next, the vacuum vessel 12 is vacuum-exhausted through a gas outlet 16 to set the pressure in the vacuum vessel 12 to 1×10⁻⁴ Pa or lower. Then, tolunitrile is introduced into the vacuum vessel 12 through a gas inlet to set the pressure in the vacuum vessel 12 to 2×10⁻⁴ Pa. Thereafter, the probe unit 70 is connected to wires on the electron source substrate 10 to carry out an energization process while water at a temperature of 70° C. is let flow in water pipes 20b of the heat conductive member 71 having the first temperature adjusting mechanism and the substrate is heated from above by the hot air blower 75 to thereby set the temperature of the substrate to 85° C. It can be said that an apparatus structured as the apparatus of this embodiment hardly suffers from the problem of temperature difference in a substrate and is capable of providing effects similar to those obtained in Embodiment 1.

This embodiment has been successful in manufacturing electron-emitting devices of excellent electron emission characteristics using the above electron source manufacturing apparatus of the present invention through an energization process performed on the devices, which is capable of preventing the substrate from cracking by reducing the temperature difference in the substrate.

The present invention can reduce the temperature difference in the substrate during the energization process and accordingly can prevent breakage of the substrate effectively. Therefore, when applied to an electron source manufacturing process, for example, the present invention is capable of mass-producing electron sources having electron-emitting devices of excellent electron emission characteristics with high yield.

What is claimed is:

1. An energization processing apparatus for performing, in a reduced-pressure atmosphere, an energization process on electric conductors which are placed on a substrate, comprising:
a vessel which has an exhaust hole and which covers the electric conductors and one region on a surface of the substrate where the electric conductors are placed, to thereby create an airtight atmosphere between the substrate and the vessel;
a first temperature adjusting mechanism for adjusting a temperature of the one region of the substrate; and
a second temperature adjusting mechanism for adjusting a temperature of the other region of the substrate.

2. An electron source manufacturing apparatus for energizing, in a reduced-pressure atmosphere, electric conductors which are placed on a substrate to form electron-emitting regions in the electric conductors, comprising:
a vessel which has an exhaust hole and which covers the electric conductors and one region on a surface of the substrate where the electric conductors are placed, to thereby create an airtight atmosphere between the substrate and the vessel;
a first temperature adjusting mechanism for adjusting a temperature of the one region of the substrate; and
a second temperature adjusting mechanism for adjusting a temperature of the other region of the substrate.

3. An energization processing method for performing, in a reduced-pressure atmosphere, an energization process on electric conductors which are placed on a substrate, comprising the steps of:
covering the electric conductors and one region on a surface of the substrate where the electric conductors are placed with a vessel which has an exhaust hole, to thereby create an airtight atmosphere between the substrate and the vessel;
reducing a pressure of the airtight atmosphere; and
heating the other region of the substrate at a temperature higher than the temperature of the one region and energizing the electric conductors.

4. An electron source manufacturing method for energizing, in a reduced-pressure atmosphere, electric conductors which are placed on a substrate to form electron-emitting regions in the electric conductors, comprising the steps of:
covering the electric conductors and one region on a surface of the substrate where the electric conductors are placed with a vessel which has an exhaust hole, to thereby create an airtight atmosphere between the substrate and the vessel;
reducing a pressure of the airtight atmosphere; and
heating the other region of the substrate at a temperature higher than the temperature of the one region and energizing the electric conductors.
